(19) United States
(12) Patent Application Publication
(10) Pub. No.: US 2016/0312920 A1
(43) Pub. Date: Oct. 27, 2016

(54) TOOL AND METHOD FOR UNLOCKING GUIDE CLAMPS FOR CABLE HARNESSES

(71) Applicant: Airbus Operations GmbH, Hamburg (DE)

(72) Inventors: Thorsten RUPPIN, Hamburg (DE); Henning JOEST, Hamburg (DE)

(21) Appl. No.: 15/138,728

(22) Filed: Apr. 26, 2016

(30) Foreign Application Priority Data
Apr. 27, 2015 (DE) 10 2015 106 478.2

(51) Int. Cl. F16L 3/23; B64C 1/14; B64F 5/00; B25B 33/00; F16L 3/10

(52) U.S. Cl. CPC F16L 3/23; B25B 33/00; F16L 3/1075; B64F 5/0081; B64C 1/1423

(57) ABSTRACT

This relates to a tool and a method for using a tool to release, unlock and open a guide clamp for cable harnesses, wherein the guide clamp is secured by a safety tab and locked with hooks. The tool encompasses a first leg and a second leg, wherein the legs are angled relative to each other and joined with each other. The insides of the legs facing each other are shaped in such a way that they can be made to abut the guide clamp. The first leg exhibits a pin, which when the insides of both legs abut against the guide clamp extends into an opening of the guide clamp in such a way as to move the safety tab of the guide clamp into a releasing position.

### CROSS-RELATED TO RELATED APPLICATIONS

This application claims priority to German Patent Application No. 10 2015 106 478.2, filed Apr. 27, 2015, which is incorporated herein by reference in its entirety.

### TECHNICAL FIELD

The embodiments described herein relate to a tool and a method for using the tool to unlock or open guide clamps for cable harnesses, wherein these guide clamps in particular serve to guide cable harnesses inside a passenger (PAX) airplane door. Use of the tool extends in particular to guide clamps inside or in the environment of the passenger doors of an Airbus A 380.

### BACKGROUND

In addition, other objects, desirable features and characteristics will become apparent from the subsequent summary and detailed description, and the appended claims, taken in conjunction with the accompanying drawings and this background.

Modernizing or retrofitting a PAX airplane door often requires that it be disassembled, to which end the electrical connection must be severed. For this purpose, the cable bundles or cable harnesses inside the PAX airplane door and surrounding structure must be detached from their guide clamps. Apart from that, it may even be necessary to remove the cable harness itself from the guide clamps in the event of its repair. The guide clamp per se is usually an injection molded plastic component, and typically encompasses an annular section, within which the cable harness can be guided when the annular section is in its closed or locked position. In order to keep the annular section in its closed position, the latter exhibits a locking mechanism, which usually encompasses a horizontal and vertical slit, a safety tab with elastic characteristics and two hooks for locking purposes. In this case, the vertical slit is necessary for releasing the safety tab, and the horizontal slit for the locking hooks. The hooks are pushed through the horizontal slit and pressed against a section of the annular section by the safety tab, which is situated in the area of the opening and can be reached by a tool via the vertical slit, in such a way as to partially seal the horizontal slit for the hooks, and block the hooks from being retracted from the horizontal slit. The guide clamp can be locked in this way.

The object of the safety tab is to secure the annular part of the guide clamp. Without releasing the latter with a special tool (or screwdriver given sufficient access), the hooks cannot be detached. The annular section can be returned to an open position again, in which the cable harness can be especially easily removed from the annular section, and hence from the guide clamp, or introduced into the annular section or passed through the latter. For explanatory purposes, it should be noted that the guide clamp has only a lock at one of the two ends that can be unlocked with the special tool. The other end has a swivel joint that cannot be completely detached even in the open state (even if this were structurally possible).

In order to unlock and open the annular section, and thus unlock and open the guide clamp as well, a screwdriver is usually inserted through the vertical slit in such a way as to move the safety tab away from the hook, with it being possible to again withdraw the latter from the slit. However, inserting the screwdriver may damage the guide clamp, in particular its surface. In addition, finding the slit with the screwdriver is difficult, cumbersome and time-intensive, in particular if the guide clamp is hidden behind a monument or similar cover for the airplane door, so that the screwdriver must be moved without any direct line of sight on the guide clamp behind the monument.

In the vast majority of cases, a screwdriver can thus not be used to unlock and open the guide clamp, because comprehensive access must be ensured. In order to gain a direct view of the guide clamp, the monuments and the like located in the visual field or working area must therefore be removed, but this leads to an enormous outlay of time and cost. Furthermore, in particular its length makes the screwdriver unwieldy to use in what is most often a very tight interior space of the PAX airplane door. Even given enough access, the screwdriver only allows a very imprecise release, since its blade is always pressed to varying depths into the slit in which the safety tab is situated. While this ensures a release, the safety tab is unfortunately bent over the entire elastic area of the plastic, resulting in a subsequent unreliable closure of the guide clamp.

### SUMMARY

Therefore, it is an object of the present embodiment to provide a tool and a method of the kind mentioned at the outset, wherein a guide clamp described above can be opened in an especially simple, user-friendly and quick manner, with the risk of damage to the guide clamp being especially low.

According to an example, the tool encompasses a first leg and a second leg, wherein the legs are angled relative to each other and joined with each other. The insides of the legs facing each other are shaped in such a way that they can be made to precisely about the guide clamp. The first leg exhibits a pin which, when the insides of both legs abut against the guide clamp, extends into an opening of the guide clamp in such a way as to move the safety tab of the guide clamp into a releasing position, in which the hooks and guide clamp can be moved into an unlocked position, and the guide clamp can be opened. The length of the leg and pin ensures that the bending of the safety tab will always be the same.

In an especially easy way, the two legs enable a suitable alignment of the tool on the guide clamp, i.e., an alignment in which the pin can be pushed through the opening, so as to move the safety tab in the above manner. This can be achieved in particular by having the shape of the leg recreate the contour of the guide clamp (concave/convex). A user of the tool, the shape of which is particularly ergonomically suited for use with one hand, receives a haptic feedback when the inside of the first leg that exhibits the pin comes to abut against a correspondingly shaped first section of the guide clamp, e.g., a leg of the guide clamp. This haptic feedback signals to the user that the tool is abutting against the guide clamp with the suitable orientation. Even if the user does not directly see the guide clamp, in particular if the latter is hidden behind a monument or the like of a PAX airplane door, it can be determined especially reliably and quickly whether the tool is suitably aligned relative to the guide clamp to be opened.

The straightforward handling of the tool also permits one-handed use with an outstretched arm in difficultly accessible areas (e.g., behind monuments/insulation). In particular, this eliminates the need for a time- and cost-intensive removal and reattachment of monuments and the like of the PAX airplane door. The new tool offers protection for the guide clamp, since during each actuation, the safety tab can always only be bent to the extent required for unlocking. This characteristic exists independently of the accessibility.

The pin may be situated at the end of the first leg facing away from the second leg, and can be introduced through the opening by moving the second leg in the direction of a free end of the pin and a second section of the guide clamp formed correspondingly with the second leg, e.g., a leg of the guide clamp, wherein an automatic centering takes place via the concave/convex shape of the leg and guide clamp. The automatic centering eliminates the need for a separate alignment of the pin relative to the safety tab. The opening that allows access to the safety tab can in particular be a slit described above.

As movement continues in this direction, the pin comes into pressure contact with the safety tab, and bends the latter so that a release comes about. Both legs abut completely against the guide clamp, generating the clear positioning, and serving as haptic feedback about the released position to the user. In this released position, the horizontal slit releases the two hooks. The hooks are now no longer locked by the safety tab. The hooks can now be brought into the unlocked position by hand, e.g. by slightly lifting the hooks, i.e., into a position in which they can be pulled out of the opening toward the legs of the tool. The hooks are lifted while preserving the positioning of the tool in the guide clamp with a slight rotational movement of the hand. As a result, either the thumb or pointer finger builds up a small force on the lower side of the two hooks, which are secured to the short leg of the annular section of the guide clamp.

The tool according to an embodiment can particularly advantageously be used to open the guide clamp with one hand. By adjusting the shape of the legs of the tool to corresponding sections of the guide clamp, the tool can be given an especially compact, in particular flat structural design, which allows its use even in especially tight areas in the environment of the PAX door of the airplane. The haptic feedback makes it possible to suitably position the tool against the guide clamp reliably and quickly, and to use the tool without damaging the guide clamp. In particular given poor accessibility, the tool can thus lower the outlay required for opening the guide clamps. As a consequence, time and costs can be economized when dismantling the PAX airplane door or replacing the cable harnesses.

In an embodiment, a ring for passing through a finger is situated in the area of the outside of the second leg, e.g. on the outside of the second leg. As a result, the second leg can be moved and guided with an especially high level of control and precision. The ring can be dimensioned in particular for passing through a ring finger, which makes it possible to move the tool especially ergonomically and precisely. The dimensions for the ring were selected in such a way as to allow all fingers to fit through and leave enough clearance available for an inclined position. As a result, the tool can be inserted onto the finger from both sides on all different positions of the doors. Therefore, the lack of a close fit does not detract from controllability, but rather promotes flexibility.

It is further provided that the legs of the tool be arranged at a right angle relative to each other. This enables an especially efficient introduction of force into the second leg, so that the safety tab can be moved into its released position exerting especially little force.

The tool can further exhibit a string or the like to be secured to the arm of a user, for example, making it possible to especially effectively prevent the tool from being lost inside the PAX airplane door or surrounding structure. It must be noted that securing the tool to the wrist, etc., is particularly advantageous when working behind cladding or the like, to ensure that the risk of tools being lost in inaccessible or difficultly accessible areas is minimized.

Finally, it is provided that the legs be fixedly joined together as a single part by a round connecting piece. The rounding is particularly advantageous from an ergonomic standpoint, and permits an especially comfortable handling of the tool.

A method that is used to unlock and then open a guide clamp of the kind mentioned at the outset, wherein the guide clamp is secured by a safety tab and locked with two hooks. The method is implemented with a provided tool of the kind described above, wherein the tool is for example used with one hand. The following procedural steps are provided according an example: placing the inside of the first leg that exhibits the pin against a first corresponding contact surface of the guide clamp, so that the pin is directed toward an opening of the guide clamp that enables access to the safety tab, placing the inside of the second leg against a second corresponding contact surface of the guide clamp, so that the pin is introduced into the opening of the guide clamp, and the safety tab is moved into its released position bending a hook section of the guide clamp, on which the hooks are situated and which exhibits the first contact surface, so that the hooks of the guide clamp are moved into their unlocked position, and pulling out the hook section from the opening of the guide clamp, so that the guide clamp is open.

In a an embodiment of the method, a finger, most often the pointer, middle or ring finger, or even the thumb, depending on the installation position, is guided through the ring, and the legs are made to abut by this finger. This is particularly advantageous from an ergonomic standpoint, and facilitates an especially exact or precise guidance of the tool.

It is further provided that the hook section be slightly bent with a finger, depending on the position with the pointer or middle finger. This is also particularly advantageous from an ergonomic standpoint, and contributes to being able to use the tool with one hand in an especially user-friendly manner for implementing the method. Once the basic principle is understood, the tool can also be used blindly, intuitively, and one-handedly behind claddings.

In the interest of avoiding repetition, reference is made to the above statements in conjunction with the tool with regard to additional advantages and advantageous embodiments of the method.

### BRIEF DESCRIPTION OF THE DRAWINGS

The various embodiments will hereinafter be described in conjunction with the following drawing figures, wherein like numerals denote like elements, and:

FIG. 1 is a perspective view of an exemplary embodiment of a tool for unlocking guide clamps for cable harnesses in the surrounding structure of PAX airplane doors,

FIG. 2 is the tool according to FIG. 1 in a top view, without the string depicted on FIG. 1,

FIG. 3A is a sectional view of part of a guide clamp, which can be released and unlocked with the tool according to FIG. 1,

FIG. 3B is a magnified sectional view of the locking mechanism of the guide clamp according to FIG. 3A,

FIG. 3C is the locking mechanism with safeguard according to FIG. 3B in a perspective rear view, and

FIG. 4 is a flowchart for an exemplary embodiment of a method for opening the guide clamp on FIG. 3.

### DETAILED DESCRIPTION

The following detailed description is merely exemplary in nature and is not intended to limit the disclosed embodiments or the application and uses thereof. Furthermore, there is no intention to be bound by any theory presented in the preceding background detailed description.

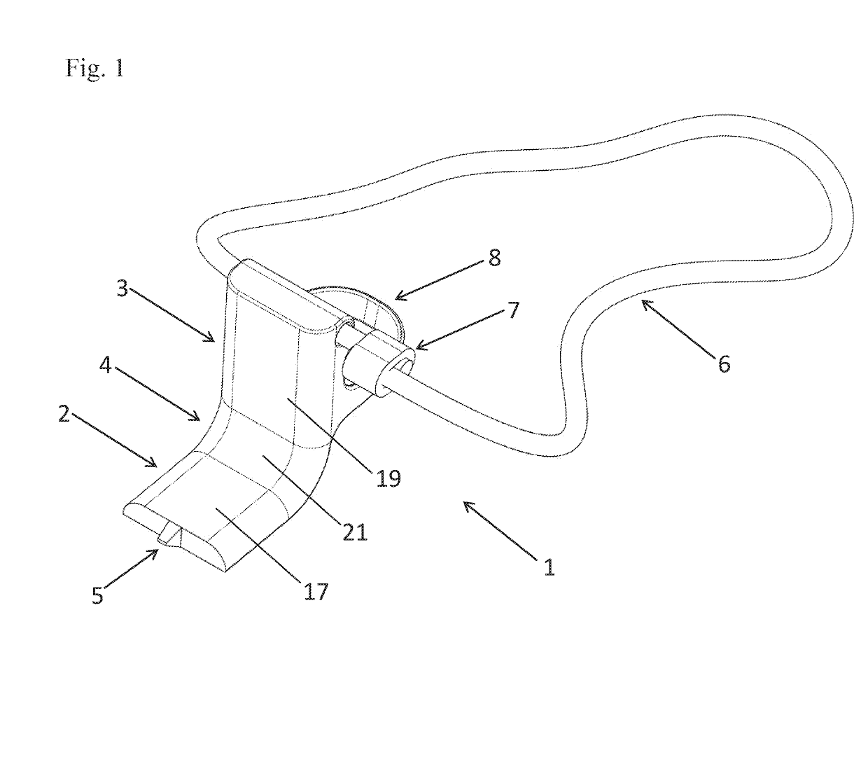

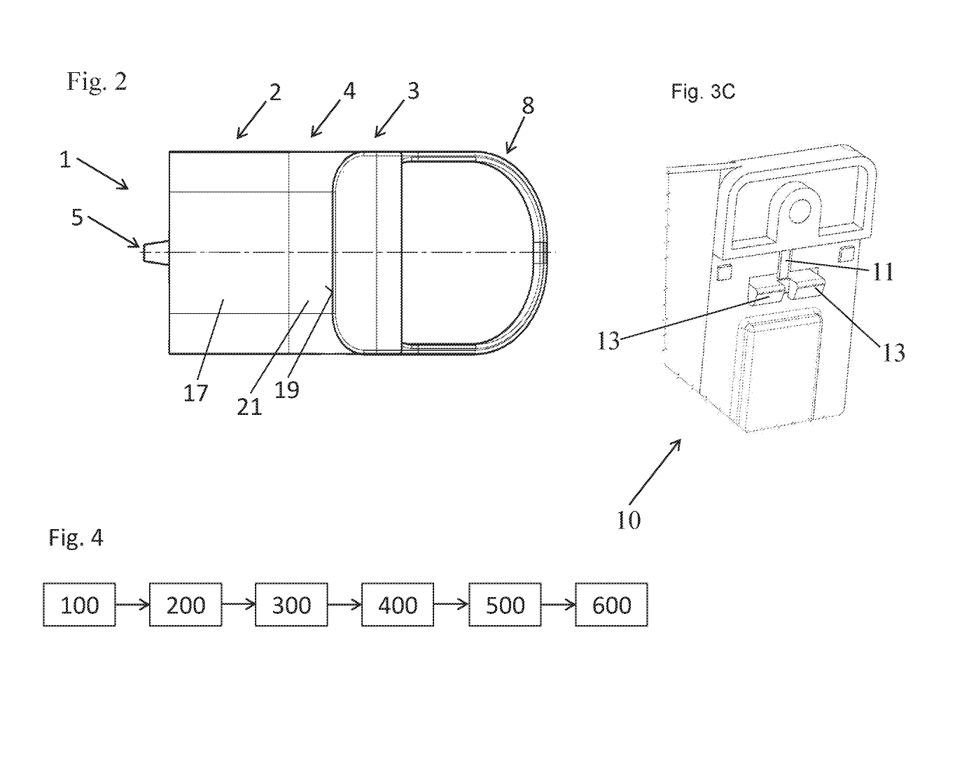

FIGS. 1 and 2 show an exemplary embodiment of a tool 1, which encompasses a first leg 2 and a second leg 3, which are arranged at a right angle relative to each other and fixedly joined with each other in a single part by a round connecting piece 4. The first leg 2 exhibits a pin 5 at its open, frontal end. A string in the form of a band 6 whose ends are fixedly joined together by a clamping ring 7 is secured to the second leg 3, and set up to be carried on the wrist of a user of the tool 1 (not shown) (FIG. 1). In addition, a ring 8 is joined with the second leg 3 as a single part, wherein the ring 8 is shaped and dimensioned in such a way that a finger, e.g., a ring finger, on the hand of the user can be inserted through it.

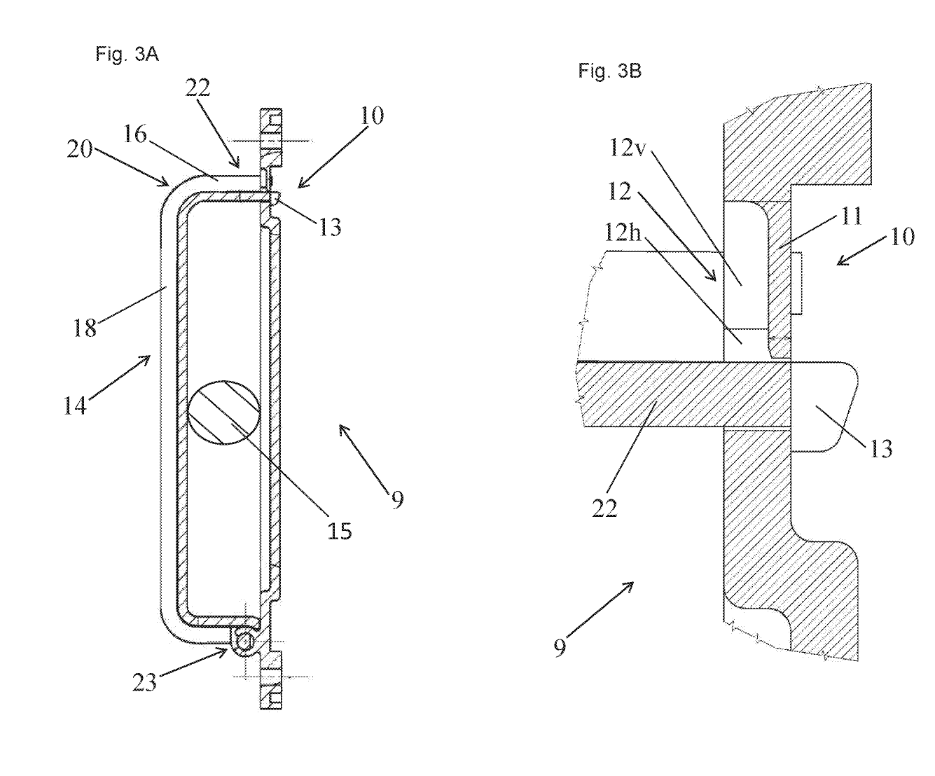

Except for the band 6 and clamping ring 7, the tool 1 is made out of a plastic material or an aluminum material, and is suitable for opening a guide clamp 9 shown on FIG. 3a to c, which exhibits a locking mechanism that encompasses a safety tab 11, an opening 12 exhibiting a horizontal slit 12h and a vertical slit 12v, and two hooks 13 guided through the horizontal slit 12h. In its position depicted on FIG. 3a to c, the safety tab 11 blocks part of the access to the horizontal slit 12h, so that the two hooks 13 secured side by side cannot be moved out of the horizontal slit 12h. In this position depicted on FIG. 3, the safety tab 11 with elastic characteristics and the hooks 13 are in their locked position.

The guide clamp 9 further encompasses an annular section 14, which is partially shown on FIG. 3, and in which a cable harness 15 is guided. The annular section 14 is rotatably mounted in a joint 23. The annular section 14 of the guide clamp 9 forms a first corresponding contact surface 16, to which the shape of an inside 17 of the first leg 2 of the tool 1 is adjusted, and a second corresponding surface 18, to which the shape of an inside 19 of the second leg 3 of the tool 1 is adjusted. The guide clamp 9 further forms an outer radius 20 between the contact surfaces 16, 18, to which the radius of the inside 21 of the round connecting piece 4 of the tool 1 is adjusted. The guide clamp 9 and cable harness 15 are situated inside a PAX airplane door (not shown).

The inside 17 of the first leg 2 of the tool 1 can be made to abut against the first corresponding contact surface 16 of the guide clamp 9, and the inside 19 of the second leg 3 of the tool 1 can be made to abut against the second corresponding contact surface 18 of the guide clamp 9. Once the insides 17, 19 have been made to abut the contact surfaces 16, 18 during exposure to a slight pressure, the pin 5 extends into the vertical slit 12v of the guide clamp 9 in such a way that the safety tab 11 of the guide clamp 9 is bent outwardly by the hooks 13, thereby moving the safety tab 11 into its releasing position, in which the hooks 13 can also be moved into an unlocked position, and in which the annular section 14, and hence the guide clamp 9, are unlocked and can be brought into an open position.

In the following, how the tool 1 according to FIG. 1 functions will be explained in greater detail based on an exemplary embodiment of the method according to FIG. 4.

In a first procedural step 100, the tool 1 according to FIG. 1 is prepared. In a second step 200, the band 6 shown on FIG. 1 is slung around the right wrist of the user (not depicted). In a third procedural step 300, the user sticks a suitable finger (all fingers except for the little finger are possible) through the ring 8 of the tool 1, and moves the tool 1 with his or her hand inside the surrounding structure of the PAX airplane door behind a monument or cladding near the PAX airplane door in such a way that the inside 17 of the first leg 2 comes to abut against the corresponding contact surface 16 of the guide clamp 9, and the pin 5 is directed toward the vertical slit 12v of the guide clamp 8, wherein the vertical slit 12v allows access to the safety tab 11.

In a fourth procedural step 400, the inside 19 of the second leg 2 is made to abut against the second corresponding contact surface 18 of the guide clamp 9. In this way, the pin 5 is introduced into the vertical slit 12v of the guide clamp 9, and the safety tab 11 is bent outwardly by the hook 13, thereby moving the safety tab 11 into its unlocked position. In this unlocked position, the safety tab 11 provides the hooks 13 with a way through the horizontal slit 12h. The annular section 14 can now be opened by pulling the hooks 13 out of the horizontal slit 12h, i.e., the annular section 13, and hence the guide clamp 9, are also in their unlocked position.

In an ensuing fifth step 500, a finger (each finger except for the little finger can be used) of the user bends a hook section 22 of the guide clamp 9 on which the hooks 13 are situated and which exhibits the first contact surface 16, so that the hooks 13 of the guide clamp 9 are slightly lifted, and thus moved into their unlocked position, in which they can be moved through the horizontal slit 12h. Finally, the hook section 22 along with its hooks 13 is pulled out of the opening of the guide clamp 9 in a sixth procedural step 600, specifically by way of its horizontal slit 12h, so that the annular section 14 is folded upward via the swivel joint 23, thereby opening the guide clamp 9.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

1. A tool for unlocking a guide clamp for cable harnesses, that is secured by a safety tab and locked with hooks, comprising:
a first leg; and
a second leg,
wherein the legs are angled relative to each other and joined with each other,
wherein the insides of the legs facing each other are shaped in such a way that they can be made to abut the guide clamp, and
wherein the first leg comprises a pin, which when the insides of both legs abut against the guide clamp extends into an opening of the guide clamp in such a way as to move the safety tab of the guide clamp into a releasing position, in which the hooks and guide clamp can be moved into an unlocked position, and the guide clamp can be opened.

2. The tool according to claim 1, wherein a ring for passing through a finger is situated in the area of the outside of the second leg.

3. The tool according to claim 1, wherein the legs are arranged at substantially a right angle relative to each other.

4. The tool according to claim 1, wherein the tool comprises a string to be secured to the arm of a user.

5. The tool according to claim 1, wherein the legs are fixedly joined together as a single part by a round connecting piece.

6. A method for opening a guide clamp, comprising:
placing the inside of the first leg that comprises the pin against a first corresponding contact surface of the guide clamp, so that the pin is directed toward an opening of the guide clamp that enables access to the safety tab,
placing the inside of the second leg against a second corresponding contact surface of the guide clamp, so that the pin is introduced into the opening of the guide clamp, and the safety tab is moved into its released position,
bending a hook section of the guide clamp, on which the hooks are situated and which exhibits the first contact surface, so that the hooks of the guide clamp are moved into their unlocked position, and
pulling out the hook section from the opening of the guide clamp, so that the guide clamp is open.

7. The method according to claim 6, wherein a finger is guided through the ring, and the legs are placed with this finger.

8. The method according to claim 6, comprising bending the hook section with a finger.
